(19) United States
(12) Patent Application Publication
(10) Pub. No.: US 2002/0053153 A1
(43) Pub. Date: May 9, 2002

(54) Electronic display system for use in publicly accessible locations for receiving data from a remote location

(76) Inventors: Bryce C. Nesbitt, Cambridge, MA (US); Kenneth J. Schmier, Berkeley, CA (US)

Correspondence Address: Gibson, Dunn & Crutcher LLP, 1801 California St., Suite 4100, Denver, CO, 80202, US

(21) Appl. No.: 09/858,055

(22) Filed: May 15, 2001

Related U.S. Application Data
(60) Provisional application No. 60/204,625, filed on May 16, 2000.

(51) Int. Cl. G09F 15/00

(52) U.S. Cl. 40/607

(57) ABSTRACT

A display apparatus which, in a preferred embodiment, advantageously serves as a real time information source for users of a transit vehicle traffic report system. In one embodiment, the apparatus comprises a pole-mounted housing having an oblong shape and being formed from two separate portions, each made of a scratch-resistant, plastic material. The two plastic portions are bolted to one another through suitable apertures in a metal pole. Each portion is enclosed by a channel member which both encloses the respective plastic portion and engages one side of the pole. Seals run along the intersection of the two plastic portions and their respective channel members. The front plastic portion encloses the electronics and provides a recess for mounting an electronic display. The rear plastic portion encloses a plurality of batteries. In other embodiments, the display system is provided in various modular portions such as for different vehicle routes having a common station or stop and for different functions such as battery module, receiver and display modules. Moreover, alternative forms of pole attachments are disclosed for different pole cross-sectional shapes and sizes.

### FIELD OF THE INVENTION

The present invention relates generally to electronic display systems for use in publicly accessible locations such as transit stops and the like. The invention is more specifically related to a pole mounted display apparatus for easy access at bus stops and the like and having an electronic display and associated electronics for informing users in regard to transportation schedules, anticipated bus arrival times, advertising information and the like.

### BACKGROUND OF THE INVENTION

The preferred embodiment of the present invention is configured for use in conjunction with a public transit vehicle arrival information system described in prior U.S. patent application Ser. No. 08/696,811 filed Aug. 13, 1996 the content of which is hereby incorporated in its entirety herein by reference and should be deemed to be a part of the disclosure hereof. Such a system is designed to permit users of public transit vehicles (i.e., buses) to learn from bus stop displays, how long they must wait before the next bus arrives at a particular bus stop. A suitable display device for such a system should meet certain criteria related to ease of activation, function including display clarity, ease of installation and maintenance, resistance to vandalism and wear and ease of access to all users including children and handicapped persons. Of course, the display device must be extremely resistant to theft and should provide some form of “self-destruct” or “dis-function” mechanism to discourage potential thieves.

In order to implement a display device which provides real time, changing information as to arrival times for transit vehicles, it is, of course, necessary to have an electronic display which can be continuously up-dated in response to changes in system conditions. For example, as a bus approaches a particular stop, the predicted time of arrival for that bus at that stop will be fine tuned with traffic, user load and weather conditions. Thus, a bus that is at first predicted to arrive at a stop at 3:14 P.M. or in ten minutes when a mile away, may subsequently be predicted to arrive at 3:18 P.M. or in six minutes when a quarter of a mile away. Moreover, as each bus on a particular route arrives at a particular stop, the projected time of arrival for the next bus at that same stop, will, of course change to a new expected time. Thus, it is important to provide a display device which is in substantially constant communication with the entire system to permit frequent display update to currently relevant information. Therefore, the display device must be electronic and thus must be physically constructed to withstand all forms of weather conditions and physical abuse while protecting the electronic display and associated electronics for communicating with the system of which the display device is a part. This construction must nevertheless be readily accessible both to users and to maintenance personnel. Users must be permitted to gain access to the display to activate the display and observe the displayed information.

Such access must be substantially universal in that children and handicapped persons such as those in wheelchairs can still readily use the display device. Maintenance personnel must not only have easy access to the display, but must also have ready access to the interior of the device for repair of electronics and replacement of parts such as batteries and the like. Such ready access as well as resistance to weather conditions dictates the need for a rugged device.

While there are many prior art examples of electronic displays for use in public places, such as train stations, airports and the like, there are no known prior art display devices which would have been suitable for satisfying all of the aforementioned criteria. The only comparable prior art devices known to applicant is the well-known parking meter which must also be sufficiently rugged to protect its contained currency and yet be sufficiently accessible to permit a user to add currency and observe the status of the time allotted for parking. However, conventional parking meters are primarily mechanical devices which are not in communication with other components of a system and which are inherently more rugged than electronic display systems.

Thus there is a need for a display apparatus suitable for use in a transit vehicle traffic reporting system and having the physical and display features necessary to meet all of the criteria for functionality, durability, installation and maintenance described above.

### SUMMARY OF THE INVENTION

The present invention comprises a display apparatus which, in one embodiment, advantageously serves as a real time information source for users of a transit vehicle traffic report system. The apparatus comprises a pole-mounted housing having an oblong shape and being formed from two separate portions, each made of a scratch-resistant, plastic material. The two plastic portions are bolted to one another through suitable apertures in a metal pole. Each portion is enclosed by a channel member which both encloses the respective plastic portion and engages one side of the pole. Seals run along the intersection of the two plastic portions and their respective channel members. The front plastic portion encloses the electronics and provides a recess for mounting an electronic display. The rear plastic portion encloses a plurality of batteries.

In other disclosed embodiments, the apparatus comprises a plurality of modules integrated either horizontally or vertically to form a multi-route configuration, where each module is dedicated to a particular vehicle route sharing a common stop or station with vehicles of other routes. Other modular embodiments comprise a plurality of function modules; i.e., one module for batteries, another for data reception and display, etc. Alternative forms of attachment depending primarily on pole cross-sectional shape, are also disclosed.

The display apparatus of the present invention thus meets the requirements for function, access, durability and resistance to weather, vandalism and theft.

It is therefore a principal advantage of the present invention to provide an electronic display apparatus as a substantially real time information source for users of a transit vehicle traffic reporting system.

It is another advantage of the present invention to provide a display device for attachment to a pole at a transit stop and which can withstand weather effects and user abuse in an unsupervised outdoor environment.

It is still another advantage of the present invention to provide an electronic display device at public facilities in a location readily accessible to even children and persons in wheelchairs.

It is yet another advantage of the invention to provide an electronic display device which is easy to install at transit vehicle stops and easy to maintain and repair.

It is yet another advantage of the invention to provide a modularized electronic display device for a transit vehicle reporting system wherein each module corresponds to the display of time of arrival information for a particular one of several vehicle routes sharing a common stop or station.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is an elevational view of a first embodiment of the invention shown installed on a bust stop pole;

FIG. 2 is a cross-sectional view of the invention taken along lines 2-2 of FIG. 1;

FIG. 3 is a cross-sectional view of the invention taken along lines 3-3 of FIG. 1;

FIG. 4 is a plan view of the invention;

FIG. 5 is a top view;

FIG. 6 is a rear view;

FIG. 7 is a bottom view;

FIG. 8 is a left side view;

FIG. 9 is a right side view thereof;

FIG. 10 is an illustrative example of one alternative form of display for the present invention;

FIG. 11 is an illustration of an alternative form of display configuration and battery placement;

FIG. 12 and 13 illustrate an alternative embodiment of the invention having a modular configuration suitable for use at vehicle stops utilized by a plurality of different routes;

FIG. 14 is a partially exploded view of the embodiment of FIGS. 12 and 13;

FIG. 15 is an illustration of an alternative embodiment comprising multiple stacked modules;

FIG. 16 is an illustration of another alternative embodiment of multiple stacked modules;

FIG. 17 is an illustration of still another embodiment having stacked functional modules;

FIG. 18 is a cross-sectional view of the modules of FIG. 17 configured for connection to a square pole;

FIG. 19 is another view of the module of FIG. 17;

FIG. 20 illustrates connection of the module of FIG. 17 to an octagon-shaped pole;

FIG. 21 illustrates one form of interconnection means for securing the module of FIG. 19 to a pole; and

FIGS. 22 to 27 illustrate three alternative forms of interconnection for connecting the module of FIG. 19 to a flat surface, a square pole and a round pole, respectively.

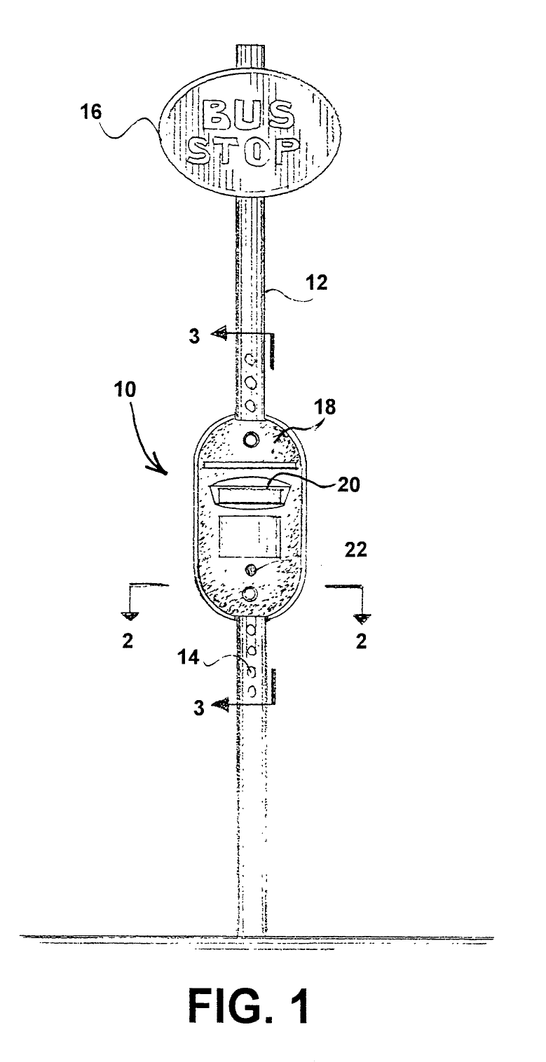

### DETAILED DESCRIPTION OF PREFERRED EMBODIMENTS

Referring to the accompanying drawings it will be seen that a display apparatus 10 in accordance with a first embodiment of the present invention is preferably affixed to a pole 12 having at least a pair of spaced holes 14 and typically supporting a bus stop sign 16 or the like. The apparatus 10 comprises a housing 18, an electronic display 20 and an activation switch 22. Housing 18 is formed of two distinct and separable portions, namely a rear portion 24 and a front portion 26. Rear portion 24 is enclosed by a channel member 32. When the two portions 24 and 26 are interconnected, the resulting housing is configured as a cylinder having substantially hemispherical axial ends.

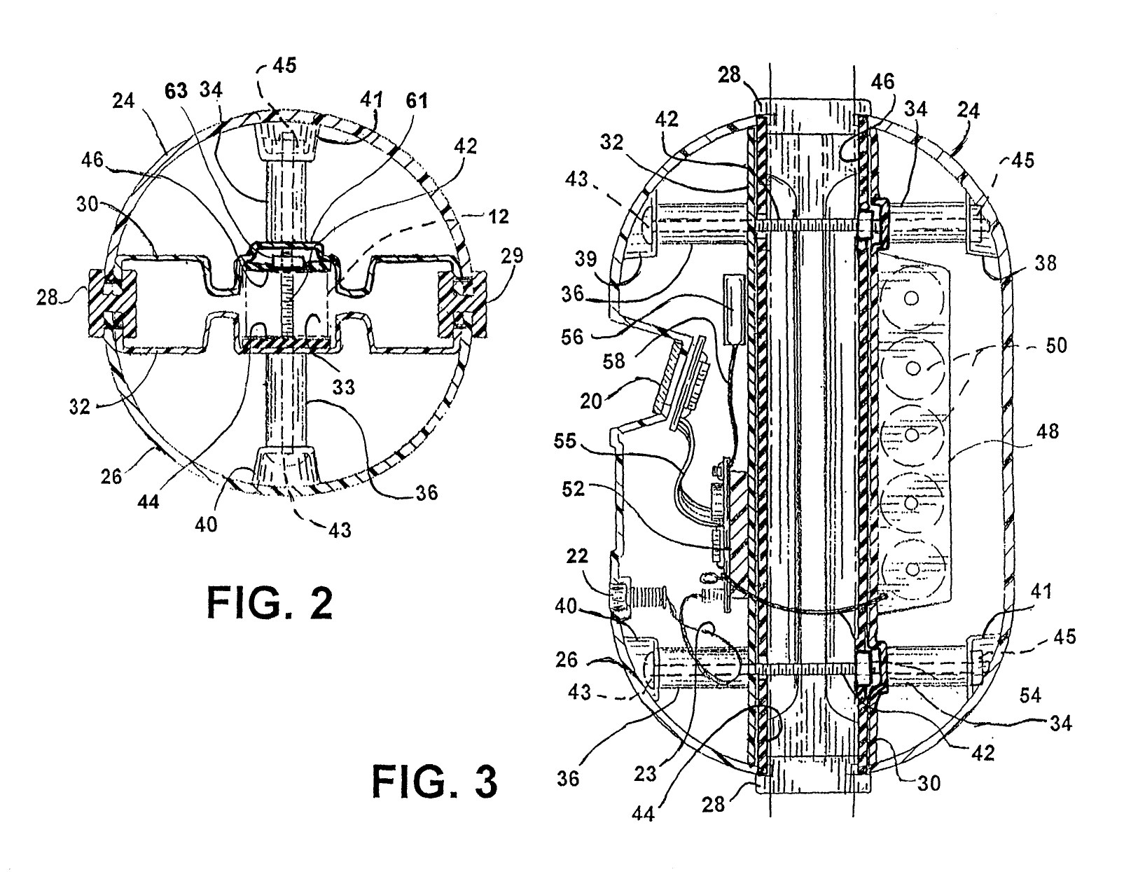

The two portions 24 and 26 are secured to the pole 12 in the manner best illustrated in FIG. 2. Channel members 30 and 32 form a central rectangular passage 33 designed to engage the pole 12. A pair of rubber-like seals 44 and 46 provide water resistance. A pair of bolts 42 extend through rear portion 24, channel member 30, channel member 32 and front portion 26. A pair of spacers 34 and 36 for each bolt 42, assure a secure interconnection without damaging the housing 18. Each bolt has a head 43 and a nut 45 which engage recesses 39, 40 and 38, 41, respectively to secure the portions 24 and 26 to each other. Nut 45 may be a specially keyed nut to further resist vandalism. A pair of seals 28 and 29 extends the full length of the housing 18 on opposite sides and engages the two portions 24 arid 26 and their respective channel members 30 and 32. Channel member 30 includes a recess 61 around each bolt 42 to permit placement of an additional nut 63 to secure the bolt even when portion 24 is removed.

The rear portion 24 and its corresponding channel member 30, form an enclosed compartment in which there is a battery enclosure 48 holding a plurality of batteries 50. The batteries are connected by a wire 54 to a circuit board 52 located in an enclosure formed between front portion 26 and channel member 32. The circuit board provides the electronic circuit and components for controlling the electronic display 20 in response to signals from a receiver 56. Receiver 56 is connected to circuit board 52 by a cable 58. Circuit board 52 is connected to display 20 by a ribbon cable 55. Activation switch 22 is connected to circuit board 52 by a wire 23. Receiver 56 is in communication with the transit vehicle traffic reporting system and may optionally include a G.P.S. receiver circuit and a transmitter to report the location of the display apparatus to other remote components in the system.

The respective housing portions 24 and 26 combine with respective channel members 30 and 32 to form two distinct modular compartments which can be removed separately from the pole for maintenance and repair. A unique aspect of the invention is that of securing portion 26 to the pole even while portion 24 is removed such as to change batteries. The channel members can be configured to accommodate virtually any pole cross-sectional shape including square, round, etc.

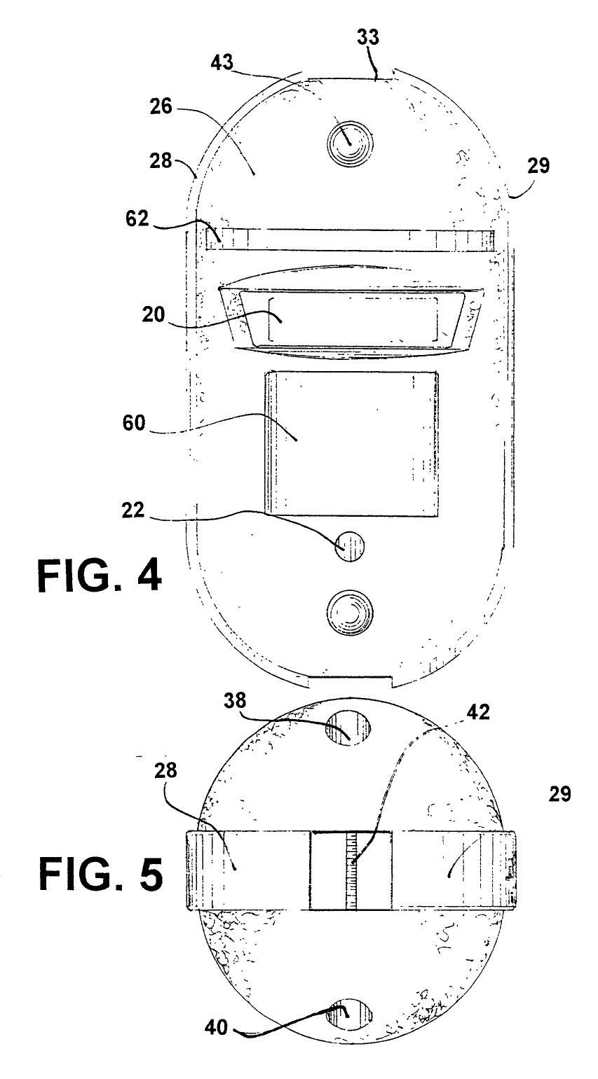

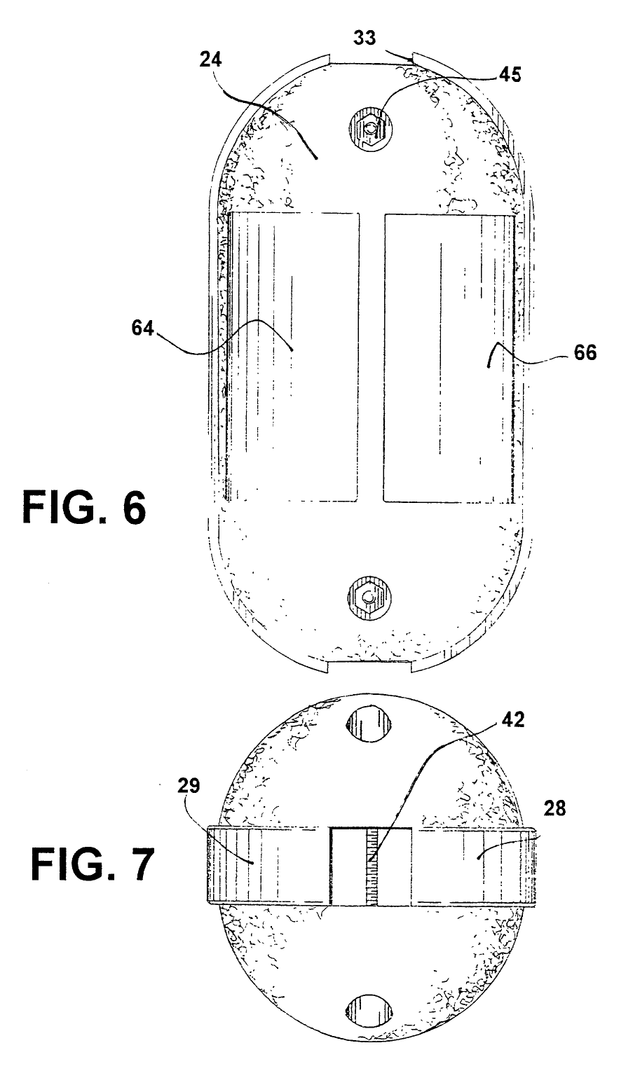

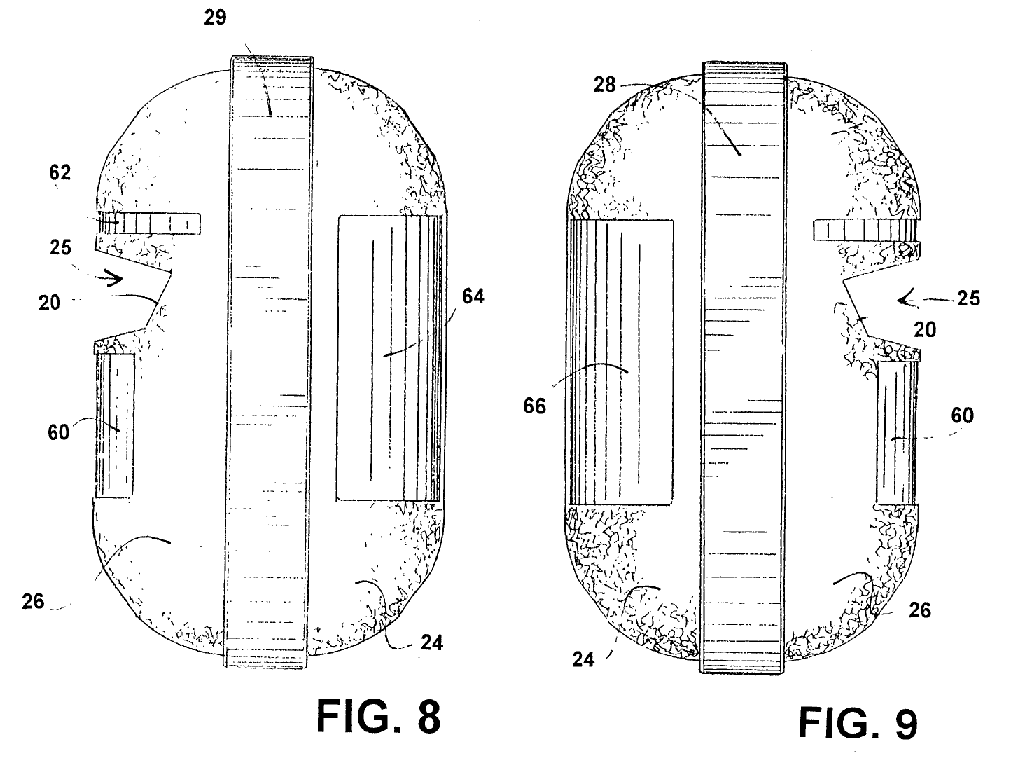

As seen best in FIGS. 4, 8 and 9, front portion 26 comprises a front inset region 60, an upper inset region 62 and a deep display recess 25, the latter providing a safe harbor for the exterior surface of the electronic display. The rear portion 24 comprises a pair of external insets 64 and 66. Insets 60, 62, 64 and 66 may be used to affix written materials such as instructions for use of the apparatus, trademarks and advertising material.

The illustrated first embodiment of the invention also provides a speaker, an active braille display system and a Talking Sign interface to address Americans With Disabilities Act requirements for the visually impaired. The apparatus is preferably mounted on the pole at about three feet above the ground so that the display is readily observable by persons in wheelchairs and children as well as adults without disabilities. Moreover, the proximity of the display to the user permits use of relatively small displays.

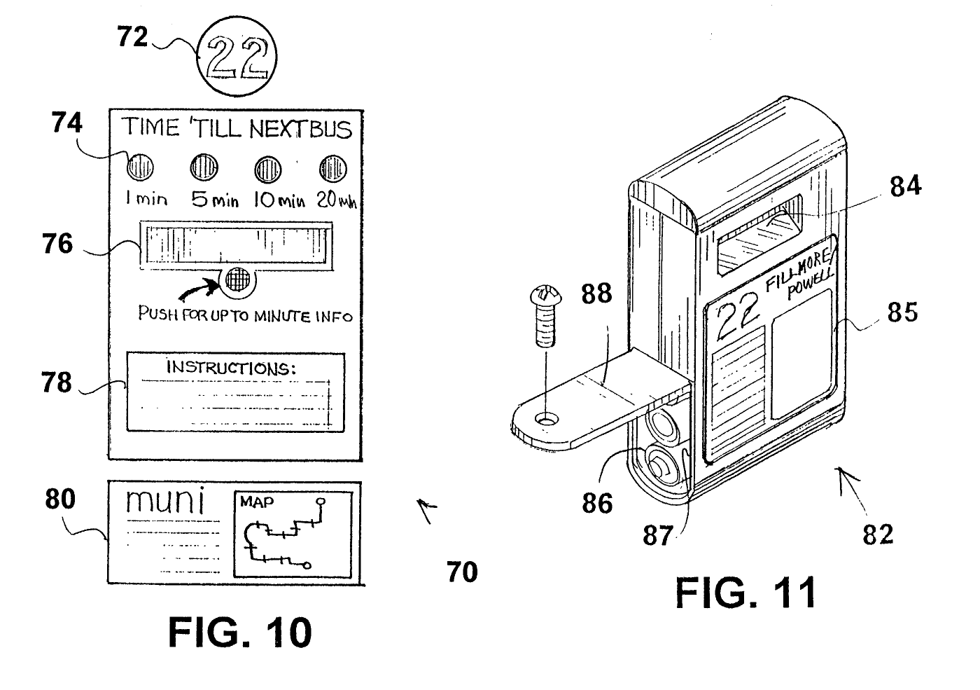

FIG. 10 illustrates one form of a display 70 that may be utilized in the present invention. The display 70 comprises a route number indication 72, a plurality of different time period indicators 74, an electronic graphics display 76, fixed graphics 78 and 80. FIG. 11 illustrates an alternative packaging configuration in a display module 82 having an electronics display 84 fixed graphics 85, batteries 86 in a battery compartment 87, the latter being accessible by means of a bolted door 88.

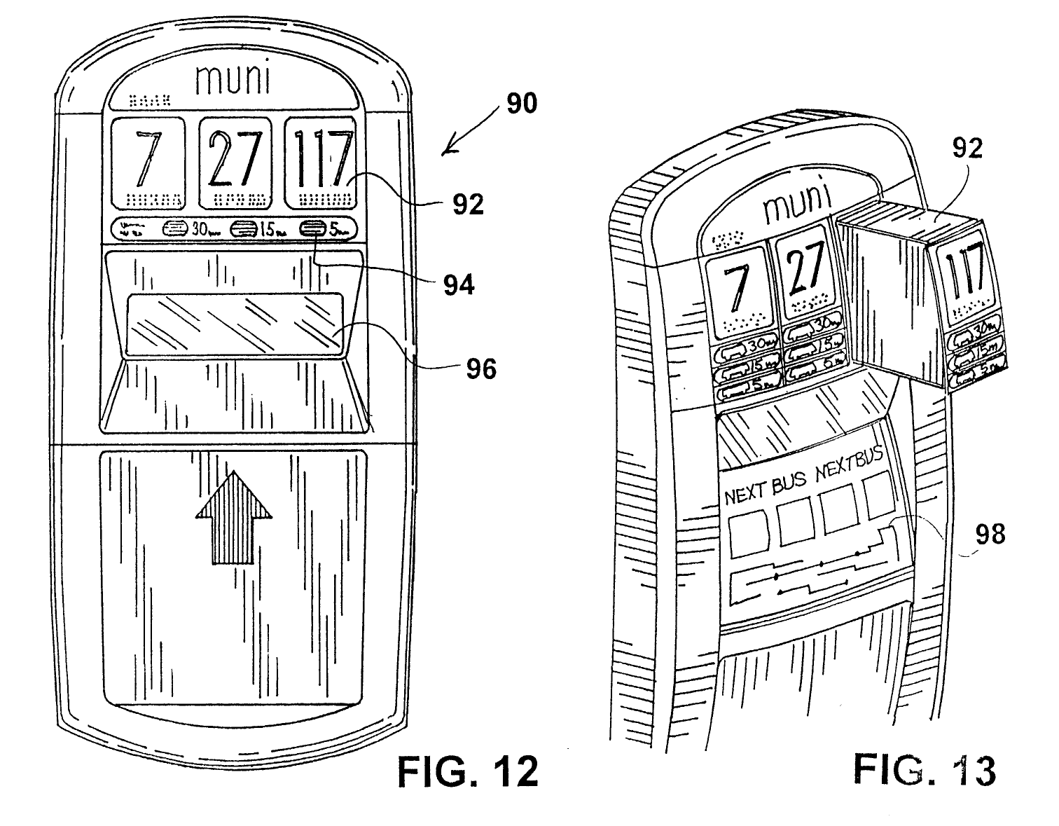

FIGS. 12 to 14 illustrate an alternative embodiment of the invention configured for providing multiple simultaneous displays for a plurality of different vehicle routes sharing a common stop or station. Display unit 90 comprises three display modules 92 which permit a user to select the route to be displayed. Time to arrive information is then provided for the selected route at different time period indicators 94 and at electronic display 96. Additional graphics such as route map 98 may be provided.

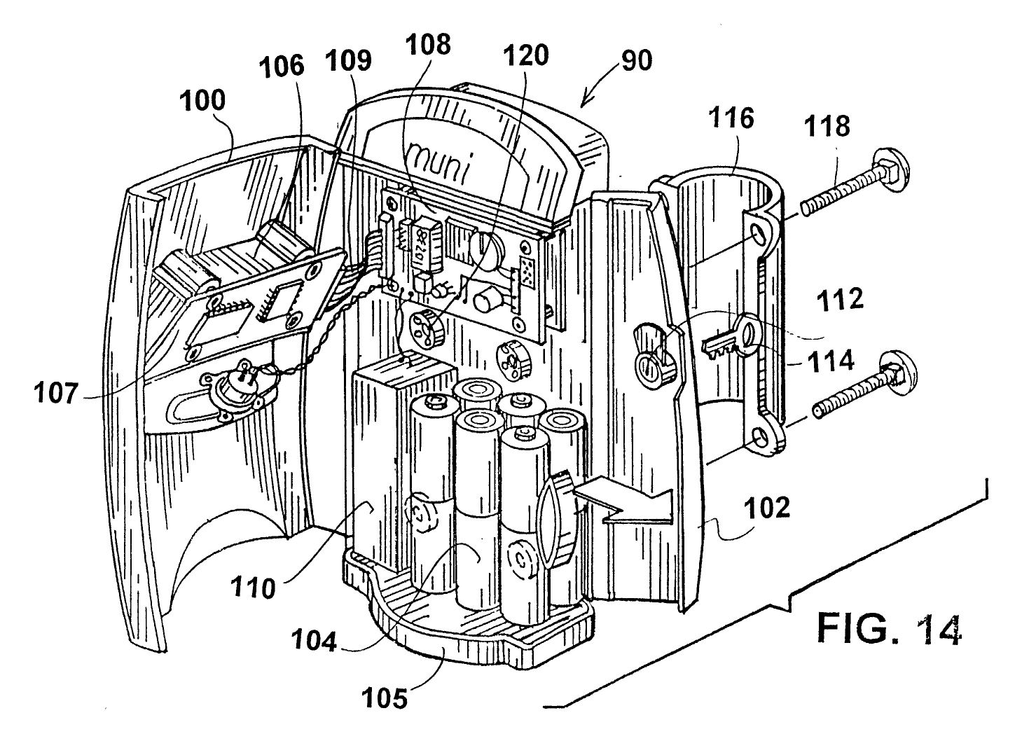

As seen best in FIG. 14, display unit 90 has main door 100 and side door 102, the latter providing side access to batteries 104 on platform 105. The display unit also provides a module receptacle 106 having a circuit board 107, the latter interfacing with a main display control board 108 by means of a ribbon cable 109. The broadcast receiver 110 is also connected to board 108 and provides input data thereto. Doors 100 and 102 are interlocked by a key lock 112 by a key 114 to secure the interior of display unit 90. The unit may be secured to a pole by a bracket 116 and a plurality of bolts 118 which are locked internally by respective locking receptacles 120.

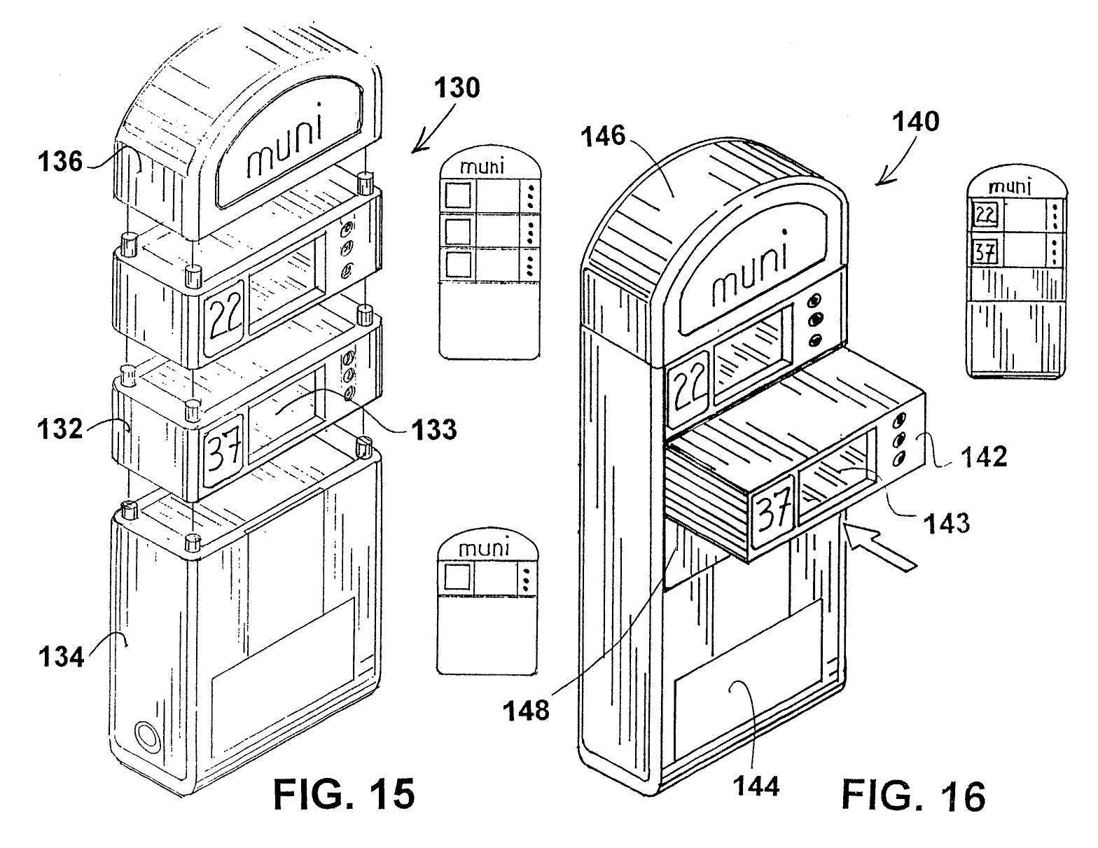

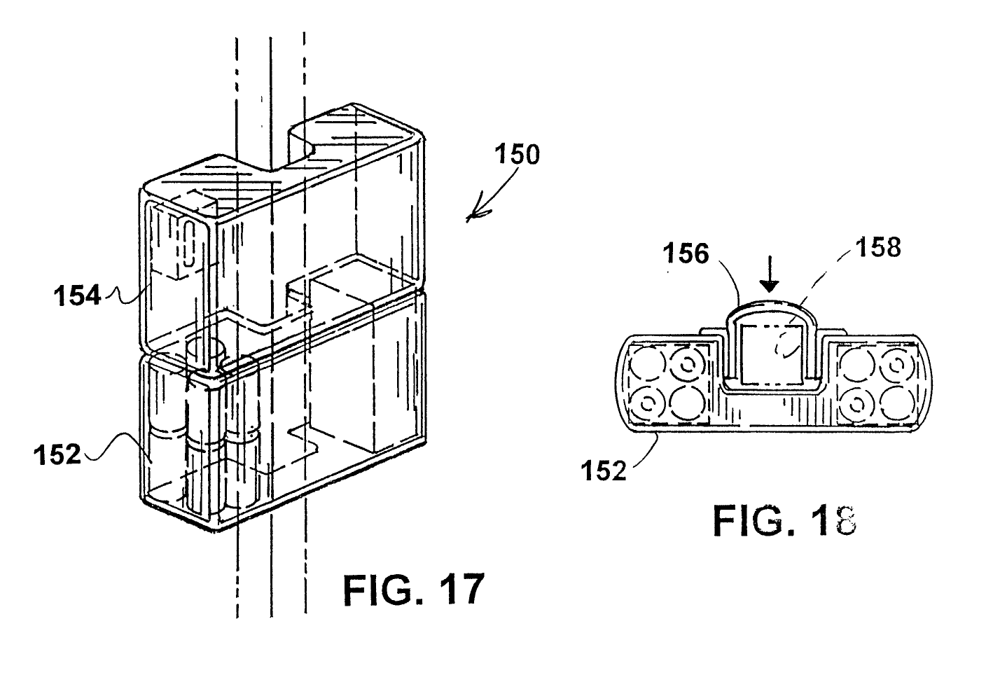

A pair of alternative multi-route modular configurations are illustrated in FIGS. 15 and 16. In FIG. 15, a display unit 130 comprises a plurality of vertically stacked route modules 132 which sit atop a battery module 134 and are capped by an end module 136, the latter optionally housing the receiver for unobstructed reception of broadcast data. In FIG. 16, a display unit 140 comprises a plurality of vertically stacked, draw-like route modules 142 which sip atop a battery module 144 and are capped by an end module 146. Blank cover 148 may be used to cover unused drawer spaces. In each of the vertically stacked configurations of FIGS. 15 and 16, each module 132 or 142, provides its own electronic display 133 and 143, respectively.

Vertically stacked configurations may be readily shaped for attaching to a pole. As shown in FIGS. 17 to 19, vertical stacking modules 152 and 154 are shaped to provide a rectangular recess 155 to partially surround a rectangular pole 158 using a locking bracket 156. However, as seen in FIGS. 20 and 21, other pole shapes, such as poly-sided pole 168 may be accommodated using a pair of hose clamps 162, each having a tightening device 164 and bolt brackets 166 for attachment to bolt holes 160.

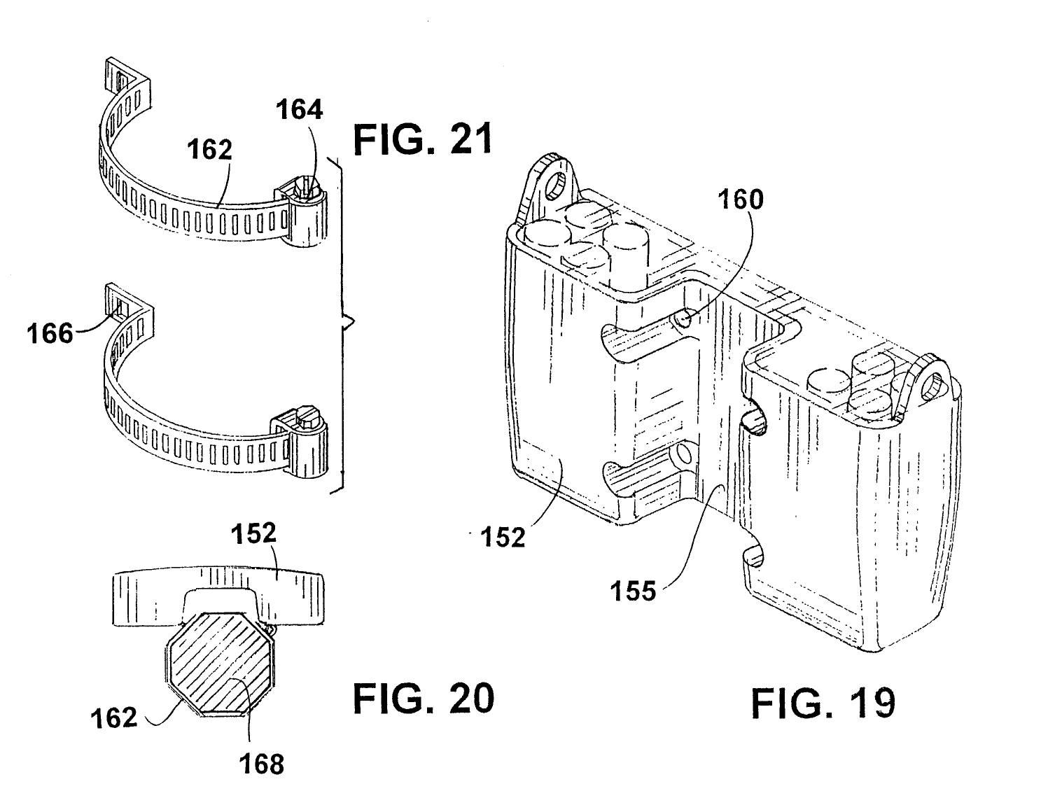

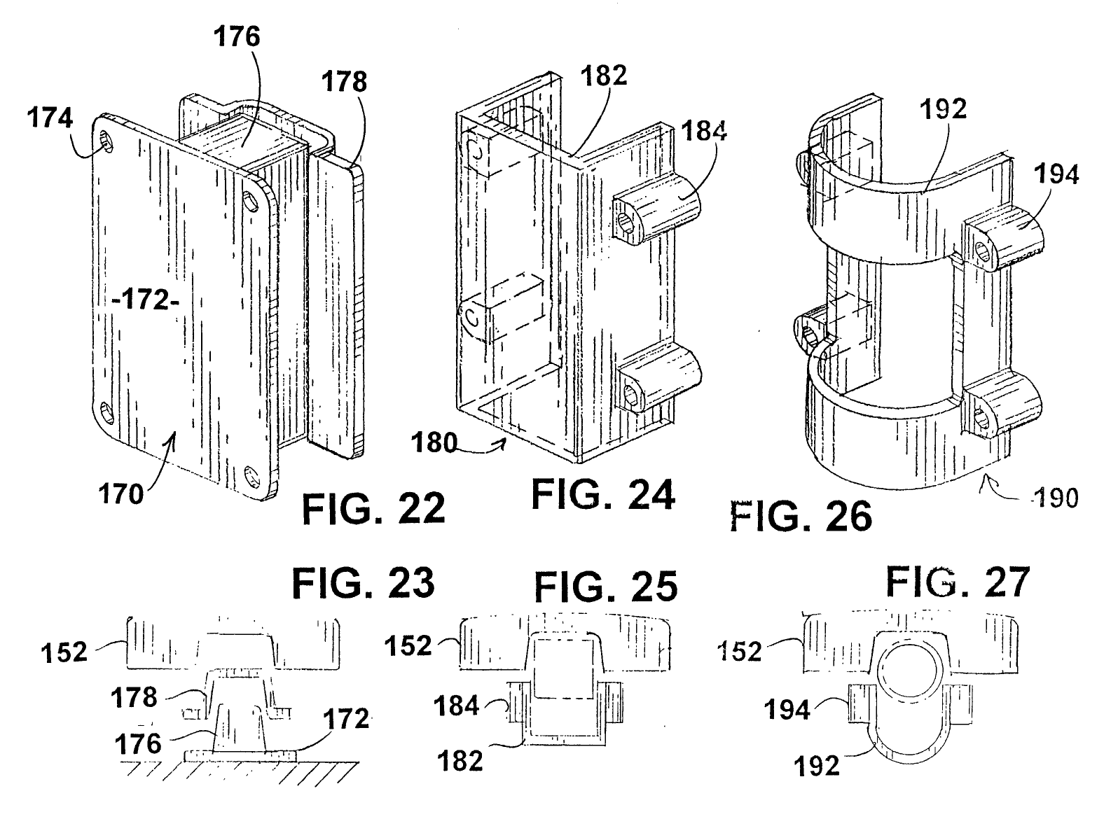

Various bracket devices and the manner in which they connect a shaped module, such as module 152 of FIG. 19, to a pole or other mounting surface, are shown in FIGS. 22 to 27. More specifically, in FIGS. 22 and 23, it will be seen that bracket 170 has a flat surface 172 having a plurality of bolt holes 174 for attachment to a flat surface. A rectangular member 176 receives a locking unit 178 which mates with the recess 155 of module 152. In FIGS. 24 and 25, a bracket 180 has a semi-rectangular member 182 and a plurality of integral bolt flanges 184 to connect module 152 to a square pole. In FIGS. 26 and 27, a bracket 190 has a horseshoe shaped member 192 with integral bolt flanges 194 to connect module 152 to a round pole.

Having thus described a number of alternative embodiments of the invention, it should be understood that still other embodiments are contemplated and that other rugged display applications are readily within the capabilities of the invention.

What is claimed is:

1. An electronic display apparatus for attachment to an existing structure; the apparatus comprising:
a first modular member having an electronically activated display and being configured for attachment to said structure on a first surface thereof; and
a second modular member being configured for attachment to said structure on a second surface thereof;
said first and second modular members being releasibly interconnected to one another in mutual compressive engagement with said first and second surfaces of said structure, respectively.

2. The apparatus recited in claim 1 wherein said second modular member comprises a battery compartment for containing at least one battery for powering said display.

3. The apparatus recited in claim 1 wherein said structure comprises a pole and wherein said first and second surfaces comprise opposed surfaces of said pole.

4. The apparatus recited in claim 1 further comprising a receiver for communication with a remote source of data for display on said electronically activated display.

5. The apparatus recited in claim 4 wherein said data comprises transit vehicle arrival prediction data relating to the predicted elapsed time before a selected transit vehicle should arrive at the location of said apparatus.

6. The apparatus recited in claim 1 wherein each said modular member comprises a scratch resistant outer portion and a channeled inner portion; the channeled inner portion being shaped to engage a pole in intimate contact; and at least one fastening device extending through both of said modular members and said pole for securing said modular members to said pole.

7. The apparatus recited in claim 1 wherein said first modular member comprises a recess for receiving said electronically activated display at a location protected from inclement weather.

8. The apparatus recited in claim 6 wherein said channeled inner portions together form a passage through which said pole extends when said apparatus is attached to said pole by said at least one fastening device.

9. The apparatus recited in claim 1 further comprising an externally accessible switch for selective activation of said display.

10. The apparatus recited in claim 1 further comprising at least one seal connected between said first and second modular members for preventing water penetration therebetween.

11. The apparatus recited in claim 6 further comprising a seal in each said channeled inner portion for preventing water leakage between said each channeled inner portion and said pole.

12. The apparatus recited in claim 1 wherein said first and second modular members, when interconnected, form a cylinder having substantially hemispherical axial ends.

13. The apparatus recited in claim 1 wherein said first modular member may be secured to said structure without the second modular member being secured to said structure.

14. A pole-mounted electronic display apparatus comprising:
a first module having an electronic display and a receiver for receiving data to be displayed on said electronic display; and
a second module having a power source for powering said display and said receiver;
said first and second modules being interconnected around said pole by at least one fastening device.

15. The apparatus recited in claim 14 wherein said power source comprises at least one battery.

16. The apparatus recited in claim 14 further comprising at least one seal between said first and second modules.

17. The apparatus recited in claim 14 comprising a seal between each of said first and second modules and said pole.

18. The apparatus recited in claim 14 wherein each of second first and second modules is configured substantially as a half cylinder.

19. The apparatus recited in claim 14 wherein said first module comprises a recess for receiving said electronic display and a switch for selective activation of said electronic display.

20. The apparatus recited in claim 14 further comprising a fastening device for securing said first module to said pole even when said second module is removed from said pole.

21. In a transit vehicle traffic reporting system having a central reporting station communicating with a plurality of remote transit vehicle stops, an electronic display apparatus at each such stop for displaying transit vehicle arrival time at the corresponding stop; each such apparatus comprising:
a first modular member having an electronically activated display and being configured for attachment to a structure at said stop on a first surface thereof; and
a second modular member being configured for attachment to said structure on a second surface thereof;
said first and second modular members being releasibly interconnected to one another in mutual compressive engagement with said first and second surfaces of said structure, respectively.

22. The apparatus recited in claim 21 wherein said second modular member comprises a battery compartment for containing at least one battery for powering said display.

23. The apparatus recited in claim 21 wherein said structure comprises a pole and wherein said first and second surfaces comprise opposed surfaces of said pole.

24. The apparatus recited in claim 21 further comprising a receiver for communication with said central reporting station for display on said electronically activated display.

25. The apparatus recited in claim 21 wherein each said modular member comprises a scratch resistant outer portion and a channeled inner portion; the channeled inner portion being shaped to engage a pole in intimate contact and at least one fastening device extending through both of said modular members and said pole for securing said modular member to said pole.

26. The apparatus recited in claim 21 wherein said first modular member comprises a recess for receiving said electronically activated display at a location protected from inclement weather.

27. The apparatus recited in claim 25 wherein said channeled inner portions together form a passage through which said pole extends when said apparatus is attached to said pole by said at least one fastening device.

28. The apparatus recited in claim 21 further comprising an externally accessible switch for selective activation of said display.

29. The apparatus recited in claim 21 further comprising at least one seal connected between said first and second modular members for preventing water penetration therebetween.

30. The apparatus recited in claim 25 further comprising a seal in each said channeled inner portion for preventing water leakage between said each channeled inner portion and said pole.

31. The apparatus recited in claim 21 wherein said first and second modular members, when interconnected, form a cylinder having substantially hemispherical axial ends.

32. The apparatus recited in claim 21 wherein said first modular member may be secured to said structure without the second modular member being secured to said structure.

33. An electronic display apparatus for attachment to an existing structure; the apparatus comprising:
a plurality of substantially contiguous modular members, each such member having an electronically activated display for displaying information different from information displayed by at least one other member display; said modular members being received in a common housing, said housing having an accessible compartment for receiving at least one power source for energizing said modular members; said housing having means for secure attachment to said existing structure.

34. The apparatus recited in claim 33 wherein said modular members are stacked side by side.

35. The apparatus recited in claim 33 wherein said modular members are stacked on above another.

36. In a transit vehicle reporting system having a central reporting station communicating with a plurality of remote transit vehicle stops, an electronic display apparatus at each such stop for displaying transit vehicle arrival times at the corresponding stop; each such apparatus comprising:
a plurality of substantially contiguous modular members, each such member having an electronically activated display for displaying information different from information displayed by at least one other member display; said modular members being received in a common housing, said housing having an accessible compartment for receiving at least one power source for energizing said modular members; said housing having means for secure attachment to said existing structure.

37. The apparatus recited in claim 36 wherein said modular members are stacked side by side.

38. The apparatus recited in claim 36 wherein said modular members are stacked on above another.
